(19) United States
(12) Patent Application Publication
(10) Pub. No.: US 2014/0353957 A1
(43) Pub. Date: Dec. 4, 2014

(54) EASILY SHEET DISPENSING NOTE PAD

(71) Applicant: 3M INNOVATIVE PROPERTIES COMPANY, St.Paul, MN (US)

(72) Inventor: Douglas P. Bodziak, Lake Elmo, MN (US)

(21) Appl. No.: 14/366,061

(22) PCT Filed: Dec. 26, 2012
(86) PCT No.: PCT/US2012/071619

§ 371 Date: Jun. 17, 2014

Related U.S. Application Data
(60) Provisional application No. 61/580,882, filed on Dec. 28, 2011.

(51) Int. Cl. B42D 5/00

(52) U.S. Cl. CPC B42D 5/003
USPC 281/2

(57) ABSTRACT

Pads comprising a plurality of sheets, each sheet having a first and a second face and a perimeter edge, wherein the sheets are arranged in stacked form with the first face of an underlying sheet oriented toward the second face of an overlying sheet and releasably bound in said stacked arrangement. The pad has a dispensing portion in which the overlying sheets overhang underlying sheets.

### FIELD

The present invention relates to note pads, in particular, note pads which can be readily dispensed with one hand.

### BACKGROUND

Note pads comprising stacked, releasably bound sheets of paper are well known. In some embodiments, the sheets are releasably bound in stacked arrangement by padding compound at one side thereof. In some embodiments, the sheets are releasably bound in stacked arrangement by repositionable adhesive on the bottom side of each sheet. 3M Company's Post-it® Repositionable Notes are a ubiquitous example of such products.

In most conventional embodiments, the sheets in a stack are of uniform size and are stacked perpendicularly. In some embodiments, one or more edges of the pad has been beveled, i.e., such that successive sheets are longer, e.g., provide an aesthetically pleasing appearance to the pad such as by providing printed matter on the beveled edge of the pad and, in some instances, on the portion of the each sheet adjacent the beveled edge. Illustrative examples are disclosed in U.S. Pat. Nos. 3,817,492 (Raymer), 4,951,569 (McNab et al.), 6,494,981 (Chen), and 6,794,002 (Shinbo) and US Patent Appln. Publn. Nos. 2004/001615 (Tsai), 2008/0128075 (Ho), and 2009/0208686 (Ho). FIG. 1 is a side view of an illustrative note pad of the prior art wherein pad 100 comprises a stack of a plurality of sheets 12a, 12b, etc. Pad 100 further comprises optional back sheet 14 underlying lower most sheet 12z. As is well known in the art, the sheets may be releasably bound in stacked arrangement, e.g., by adhesive 20 on the second side of each sheet or with a padding compound or member (not shown) on an edge of the stack. Sheets are removed from the stack by gripping removal or dispensing portion or edge 17 by hand. FIG. 2 is a side view of another illustrative note pad of the prior art wherein pad 200 comprises a stack of a plurality of sheets 12a, 12b, etc. Pad 200 further comprises back sheet 14 underlying lower most sheet 12z. As is well known in the art, the sheets may be releasably bound in stacked arrangement by padding compound 15 on one edge of the stack. The stack is beveled in removal or dispensing portion 18 such that each successive underlying sheet is larger than the overlying sheet. As disclosed in U.S. Pat. Nos. 3,817,492, 4,951,569, and 6,491,984, designs, artwork, or other indicia or legends may be provided on such beveled portions.

A challenge with conventional note pads is that attaining a grip of only the top most sheet such that it can be individually removed from the pad is often difficult. Separating and lifting the top most sheet apart from the underlying sheet by thumb or finger can be difficult, entailing in many instances several attempts to achieve grip and resulting in worn or dirtied portions of the removed sheet and underlying sheet(s). One solution to this challenge has been to provide so-called pop-up note pads in which adhesive backed sheets are arranged in Z-stack arrangement with the top most sheet being presented so as to be easy to individually grip and remove. An illustrative example is disclosed in U.S. Pat. No. 4,781,306 (Smith).

The need exists for a note pad from which sheets can be removed easily and cleanly.

### SUMMARY

The present invention provides note or memo pads from which single sheets may be easily dispensed by simple hand motion.

In brief summary, a note pad of the invention comprises a plurality of sheets, each sheet having a first and a second face and a perimeter edge, wherein the sheets are arranged in stacked form with the first face of an underlying sheet oriented toward the second face of an overlying sheet and releasably bound in said stacked arrangement. The note pad has a dispensing portion in which the overlying sheets overhang underlying sheets, i.e., the perimeter edges of the overlying sheets in that portion of the pad extend beyond the respective edges of underlying sheets.

Note pads of the invention have a novel configuration that provides surprising convenience and ease of use.

### BRIEF DESCRIPTION OF DRAWING

The invention is further explained with reference to the drawing wherein:

FIGS. 1 and 2 are each a side view of an illustrative note pad of the prior art;

FIG. 3 is a side view of an illustrative embodiment of a note pad of the invention;

FIG. 4 is a perspective view of an illustrative embodiment of a sheet used in a note pad of the invention;

FIG. 5 is a side view of another illustrative embodiment of a note pad of the invention;

FIG. 6a is a perspective view of an illustrative embodiment of a note pad of the invention; and

FIG. 6b is a perspective view of an illustrative note pad of the prior art.

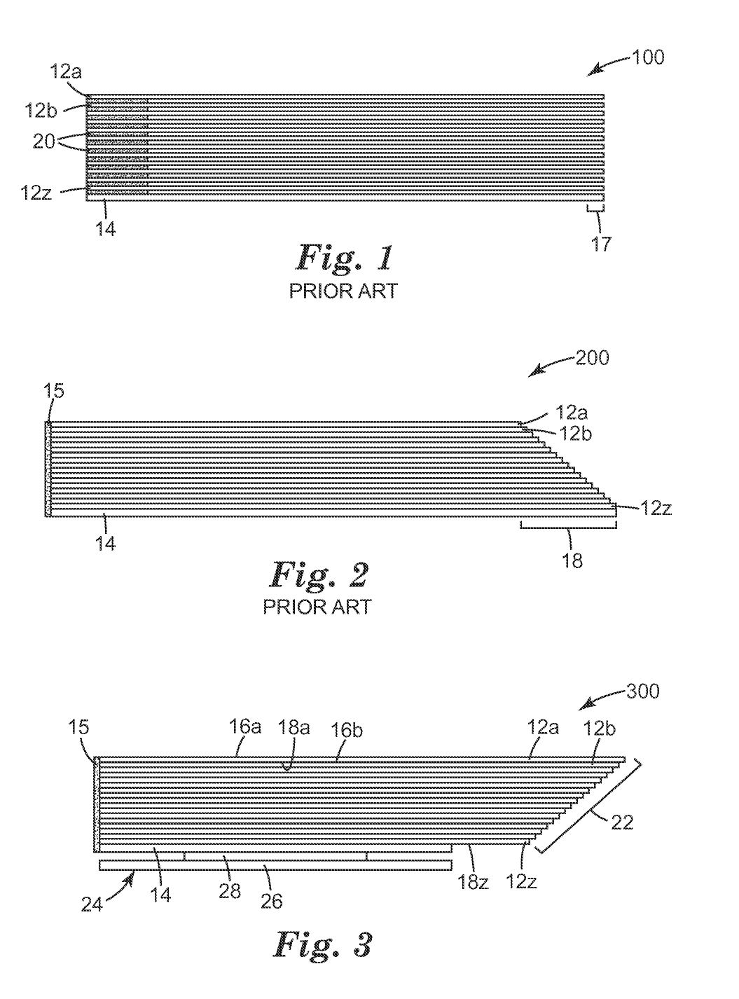

These figures are not to scale and are intended to be merely illustrative and not limiting. Like reference numerals are used for like components throughout.

### DETAILED DESCRIPTION OF ILLUSTRATIVE EMBODIMENTS

For purposes of clarity and without intending to be unduly limited thereby, the sheets in any group of two sequentially stacked sheets are referred to as an overlying sheet and an underlying sheet, respectively, with the front or first face of the underlying sheet being oriented to the second or back face of the overlying sheet.

FIG. 3 shows an illustrative a note pad of the invention 300 comprising a plurality of sheets 12a, 12b, et seq. Each sheet has a first or front face 16a, 16b, et seq., and a second face or back face 18a, et seq. The sheets are arranged in stacked form with the first face 16b of an underlying sheet oriented toward the second face 18a of an overlying sheet with the exception of lower most sheet 12z whose second face 18z is oriented toward optional backsheet 14. In the embodiment shown, the sheets are releasably bound in said stacked arrangement by padding compound 15.

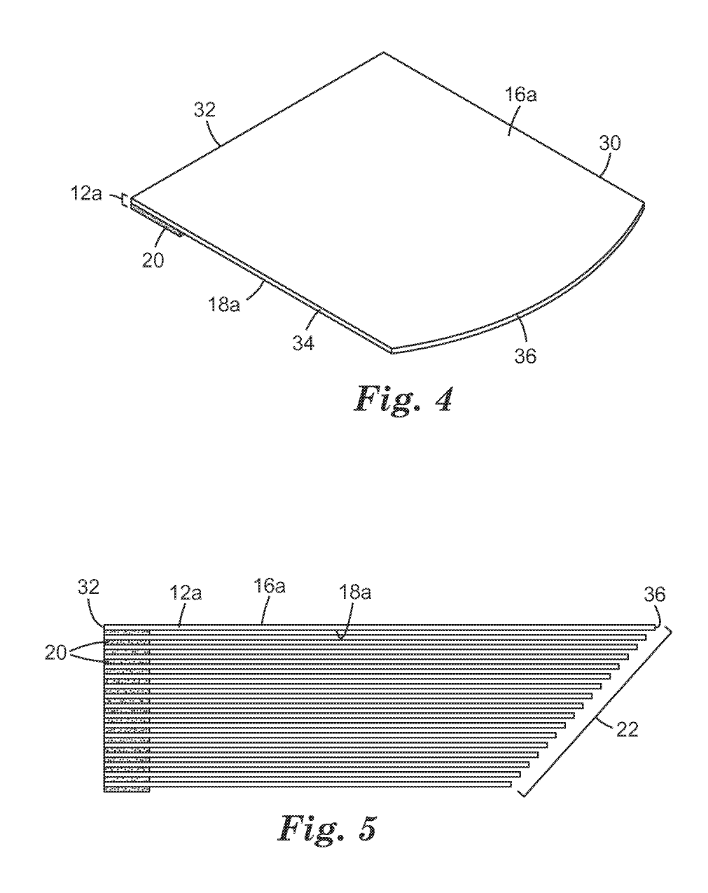

Alternatively, the sheets can be releasably bound in the stacked arrangement using an adhesive on portions of the back face of each sheet. In use, when such a sheet is removed from the stack it can be adhered to an adherend as desired with the adhesive. FIG. 4 shows an illustrative embodiment of a sheet 12a having front face 16a and back face 18a. Optional repositionable adhesive 20 is disposed on a portion of the back face of sheet 12a, in this embodiment in the form of a strip or segment running substantially parallel to the side edge 32 opposite dispensing edge 36. When stacked in a pad arrangement, such adhesive will adhere to the front face of an underlying sheet (not shown), then upon removal from the pad, the adhesive will provide adhesion to secure the sheet to an adherend as desired. Such a pad would be similar to the embodiment shown in FIG. 3 but not have the padding compound and the sheets would have adhesive on the second or back face thereof.

Selection of suitable adhesive, if used, will be dependent in part upon the desired application. In addition to providing releasable adhesion to an underlying sheet in the stack, the adhesive should provide desired adhesion, e.g., repositionable, one time removable, or permanent adhesion, to the intended adherend. Suitable adhesives may be selected from the group consisting of pressure sensitive adhesives, heat activated adhesives, actinically activated adhesives, and chemically activated adhesives.

When a sheet is removed from the pad, the adhesive on the back face of that sheet should preferentially release from the front face of the underlying sheet and remain on the back face of the sheet being removed. Those skilled in the art can readily achieve such adhesive performance, e.g., by formulation of adhesive composition, application of release promoting coatings to the subject portions of the front face of the sheets, application of adhesion promoting coatings to the subject portions of the back face of the sheets, etc. After removal from the pad, the adhesive should provide desired adhesion to adherends. In some preferred embodiments, the adhesive will be selected to provide repositionability such as the adhesives used in 3M Post-it® Notes.

Selection of how large a portion of the back face is covered by adhesive will be selected based in part upon the intended application. In many applications such as repositionable notes, the adhesive will be applied as a strip, e.g., typically in the range of about 0.6 to about 2 centimeter (about 0.25 to about 0.75 inch) wide. In some other embodiments the adhesive will cover greater portions of the back face of the sheet, e.g., substantially covering most of the back face of the sheet though often not covering a portion adjacent the dispensing edge 36.

The sheets in pads of the invention will typically comprise a flexible material, e.g., paper, metal films, plastic films, and multilayer combinations thereof. Selection of the sheet material will depend in large part upon the desired application. For instance, typically it should exhibit sufficient tensile strength to permit removal from the pad stack without tearing, is of suitable dimensional stability to undergo some bending as it is removed from the pad stack and then to lay flat after application to an adherend, if desired, and capable of withstanding intended conditions of use as desired such as temperature and humidity. Those skilled in the art will be able to readily select suitable sheet material for use in the invention without difficulty or undue effort. Many commercially available paper and other sheet materials of suitable basis weight, color, flexibility, tensile strength, foldability, etc. are among the sheet materials suitable for use in the invention.

Front face 16a of at least some, and typically preferably all, of the sheets will typically be a writable surface, e.g., receptive to application of writing with writing instruments such as markers, pens, and pencils. In some embodiments, front face 16a may bear preprinted legends, e.g., business logos, “From The Desk Of . . . ”, coupon information, shopping list categories and items, etc., and, if desired, also be writable.

Referring to FIG. 4, sheet 12a has a perimeter edge comprising in this instance three side edges 30, 32, 34 and dispensing edge 36. In the embodiment shown, each of the side edges is straight and dispensing edge 36 is curved. As desired, one or more of the side edges may be curved or straight, and the dispensing edge may be straight. If desired, the sheets in a stack may comprise fewer or more side edges.

Turning to FIG. 3, in accordance with the invention, the sheets are stacked in a note pad such that the note pad has a dispensing portion 22 in which the dispensing edges of overlying sheets overhang underlying sheets. When thusly configured, the dispensing edge of the top most sheet may be readily engaged, grasped, and removed from the pad with a single hand.

In typical embodiments, the sheets are arranged such that the perimeter edges of the sheets are aligned. The alignment may be such that the perimeter edges of stacked sheets define a line that is substantially perpendicular to the plane of the sheets, except for the dispensing edges of the sheets in the dispensing portion of the pad, or at different portions of the stack the respective perimeter edges of the stacked sheets outside the dispensing portion may define lines that are offset from perpendicular orientation if desired. In accordance with the invention, the perimenter edges of the sheets within the dispensing portions thereof will define a line with the overlying sheets having the overhang described herein. As will be understood by those skilled in the art, the sides of pad, including the collective perimeter edges of the stacked sheets and the exposed side of the padding compound, if any, may have desired indicia, images, or other graphic matter thereon.

In some embodiments, the sheets may be of substantially uniform shape and size such that when arranged in a stack with a dispensing portion as described herein, in the opposite portion of the stack the perimeter edges of successive sheets from top most to bottom most will extend out increasingly further.

The severity or degree of the undercut by which the dispensing edges of overlying sheets extend beyond the dispensing edges of underlying sheets can be readily selected by those skilled in the art. If the degree of undercut or bevel is too little, then the enhanced ability to easily select the single top most sheet will be diminished or unrealized. If the degree of undercut or bevel is too great, there may be a tendency for the sheets in the stack to become bowed over time such that the stack develops an aesthetically undesireable appearance. In many embodiments using conventional paper sheets, undercut angles of from about 10° to about 80° will be useful with undercut angles in the range from about 30° to about 60° often being preferred, and undercut angles in the range from about 40° to about 60° being most preferred.

Pads of the invention may be manufactured using known techniques, e.g., by cutting bevel edges into stacked pads as described in U.S. Pat. Nos. 3,817,492 (Rahmer), 4,951,569 (McNab et al.), or 6,494,981 (Chen), but instead inverting the orientation of the bevel such that the dispensing edges of overlying sheets extend beyond those of underlying sheets in accordance with the invention. In embodiments comprising relatively large adhesive portions on the back face of the sheets where it may be difficult to effectively fold a pad during the cutting step, use of guillotine cutting devices directed at a selected angle to the pad to render the desired bevel and dispensing edge may be better suited.

In preferred embodiments, the pad may further comprise a stabilization component to impart stability to the pad as the top most sheet is removed therefrom. For instance the pad may be mounted on a dispenser, e.g., the bottom most sheet adhered to a weighted member, desk top etc. In FIG. 3, pad 300 further comprises attachment system 24 comprising holding film 26 attached to bottom side of back sheet 14 by attachment mechanism 28. Such attachment systems are disclosed in U.S. Pat. No. 8,261,937 (Bodziak et al.). Pads of the invention may be mounted on supports in other orientations as desired, e.g., on somewhat upright surfaces such as walls and store shelves, on overhead surfaces such as automobile sun visors, the bottom of cabinet shelves, etc. As will be understood, the pad may be mounted through the bottom side thereof or via a side edge thereof, e.g., via the padding compound, if any.

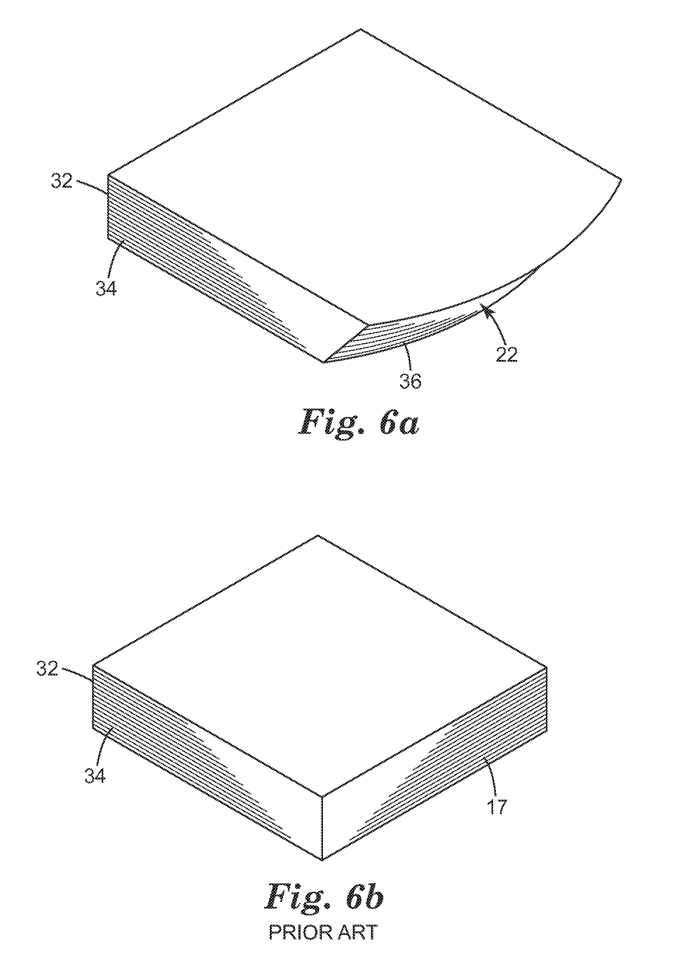

FIGS. 6a and 6b show an illustrative embodiment of a note pad of the invention and a conventional note pad of the prior art, respectively. In FIG. 6a, edges 36 of the sheets in dispensing zone 22 are in overhanging arrangement in accordance with the invention. In this embodiment, the other perimeter edges of the sheets are in conventional arrangement, i.e., parallel with each other and perpendicular to the general plane of the stack. In this embodiment, edges 36 of the sheets are curved. In FIG. 6b, all of the side edges of the sheets are in conventional arrangement, i.e., parallel with each other and perpendicular to the general plane of the stack, including the edges in removal portion 17. In this embodiment, the edges of the sheets in the removal portion are straight.

For convenience, the present invention has been described with reference to note pads. It will be understood that pads of the invention may be used for purposes other than notes, e.g., name tags, store coupons, etc.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. The complete disclosure of all patents, patent documents, and publications cited herein are incorporated by reference.

1. A pad comprising a plurality of sheets, each sheet having a first and a second face and a perimeter edge, wherein the sheets (1) are arranged in stacked form with the first face of an underlying sheet oriented toward the second face of an overlying sheet, (2) are releasably bound in said stacked arrangement, and (3) each have an adhesive portion on the second face thereof, and wherein said note pad has a dispensing edge in which overlying sheets overhang underlying sheets.

2. The pad of claim 1 wherein the sheets are arranged such that the perimeter edges thereof are aligned.

3. The pad of claim 2 wherein the perimeter edge of each sheet comprises a side edge and a dispensing edge wherein the sheets are arranged such that the side edges thereof define a line substantially perpendicular to said sheets.

4. (canceled)

5. The pad of claim 1 further comprising padding compound releasably binding said sheets in said stack.

6. The pad of claim 1 wherein the length of each underlying sheets is sequentially less than the length of the sheet overlying such underlying sheet by a given increment.

7. The pad of claim 1 wherein each of said sheets is of substantially similar shape and size.

8. The pad of claim 1 wherein the size of said sheets decreases sequentially from top down by a given increment.

9. The pad of claim 1 further comprising a stabilization component.

10. The pad of claim 1 wherein the first face of at least some of said sheets is writable.

11. The pad of claim 1 wherein the first face of at least some of said sheets has a preprinted legend thereon.
